(19) United States
(12) Patent Application Publication
(10) Pub. No.: US 2006/0224090 A1
(43) Pub. Date: Oct. 5, 2006

(54) Apparatus and method for stiffening tissue

(76) Inventors: Isaac Ostrovsky, Wellesley, MA (US); Michael Madden, Princeton, MA (US); Jon T. McIntyre, Newton, MA (US); Jozef Slanda, Milford, MA (US)

Correspondence Address: FAY KAPLUN & MARCIN, LLP, 15O BROADWAY, SUITE 702, NEW YORK, NY, 10038, US

(21) Appl. No.: 11/092,463

(22) Filed: Mar. 29, 2005

(51) Int. Cl. A61H 1/00

(52) U.S. Cl. 601/2

(57) ABSTRACT

An apparatus for stiffening tissue comprises an ultrasound element including an array of ultrasound crystals arranged on a surface, the surface shaped so that energy generated by the crystals converges on a predetermined focusing area. A method of treating tissue comprises positioning adjacent a target portion of tissue to be treated a probe including an ultrasound element, a geometry of the ultrasound element focusing ultrasound energy generated thereby on a predetermined focus area, adjusting the position of the probe so that the predetermined focus area is located at the target portion of tissue and energizing the ultrasound element to treat the target portion of tissue.

### FIELD OF INVENTION

The present invention generally relates to medical apparatus and treatment methods. More particularly, the present invention describes an apparatus and method to stiffen tissue, particularly to treat urinary incontinence and, more particularly, stress incontinence.

### BACKGROUND

Stress urinary incontinence occurs when tissue supporting the pelvic floor no longer provides sufficient support to the bladder neck and urethra, particularly the proximal urethra. In this condition, the bladder pushes against the urethra. Pressure from the abdominal muscles (e.g. during such activities as laughing, sneezing, coughing, exercising or straining to lift objects) can then cause undesired urine emissions. Females whose pelvic floors have stretched due to, for example, childbirth, obesity, etc. are more likely to suffer from stress incontinence.

One treatment for stress incontinence utilizes radio frequency (RF) energy delivered to tissue in the pelvic floor, specifically the endopelvic fascia (EPF) which lies from about one half to three centimeters beneath the surface of the vaginal wall. The RF energy thermally denatures collagenous fibers in the tissue, shrinking and stiffening the EPF to support, stabilize and reposition the proximal urethra and the bladder neck. Typically, the RF energy is delivered by manually waving an RF applicator over the target tissue (e.g. EPF) either through a transvaginal incision or over the lateral and medial surfaces of the vaginal wall. The RF applicator must be in direct contact with the surface tissue when be applied.

In these procedures the user must provide a constant rate of waving over the target tissue solely through manual control of the device to ensure that the RF energy sufficiently and uniformly stiffens the EPF. Similarly, the user must ensure that the coverage of the target has been thorough and complete. In addition to maintaining a constant wave rate and completely covering the target tissue, the user must aim the RF device properly to be certain not to damage collateral structures, such as the urethra, nerves or other abdomino-pelvic organs and tissues.

### SUMMARY OF THE INVENTION

The present invention is directed to an apparatus for stiffening tissue comprising an ultrasound element including an array of ultrasound crystals arranged on a surface, the surface shaped so that energy generated by the crystals converges on a predetermined focusing area.

The present invention is further directed to a method of treating tissue comprising positioning adjacent a target portion of tissue to be treated a probe including an ultrasound element, a geometry of the ultrasound element focusing ultrasound energy generated thereby on a predetermined focus area, adjusting the position of the probe so that the predetermined focus area is located at the target portion of tissue and energizing the ultrasound element to treat the target portion of tissue.

### BRIEF DESCRIPTION OF THE DRAWINGS

The accompanying drawings are included to provide a further understanding of the invention and are incorporated in and constitute part of the specification, illustrate several embodiments of the invention and, together with the description, serve to explain examples of the present invention. In the drawings:

FIG. 1 shows a perspective view of a first embodiment of an apparatus for administering ultrasound energy to tissue according to the present invention;

FIG. 2 shows a sectional view of the apparatus of FIG. 1 along the line A-A;

FIG. 3 shows a side profile of the emitted ultrasound energy from the apparatus of FIG. 1;

FIG. 4 shows a perspective view of a second embodiment of an apparatus for administering ultrasound energy to tissue including an alternate coupling component;

FIG. 5 shows a side view of third embodiment of an apparatus for administering ultrasound energy to tissue;

FIG. 6 shows a perspective view of an ultrasound element according to a further embodiment of the apparatus;

FIG. 7 shows a perspective view of an ultrasound element according to a still further embodiment of the apparatus; and

FIG. 8 shows a view of a device according to the present invention in position within the body to perform a method according to the present invention.

### DETAILED DESCRIPTION

The present invention may be further understood with reference to the following description and the appended drawings, wherein like elements are referred to with the same reference numerals. The present invention relates generally to an apparatus and method to stiffen tissue, particularly collagenous tissue, such as superficial and deep fascia. While the present invention will be described with reference to noninvasive treatment of urinary incontinence, it is contemplated that the same apparatus may be used transrectally in the treatment of an enlarged prostate (BPH), fecal incontience or sphincter remodeling, transesophogeally for gastroesophageal reflux disease (GERD), or in any other manner for a disorder or condition where it is desired to shrink or stiffen tissues.

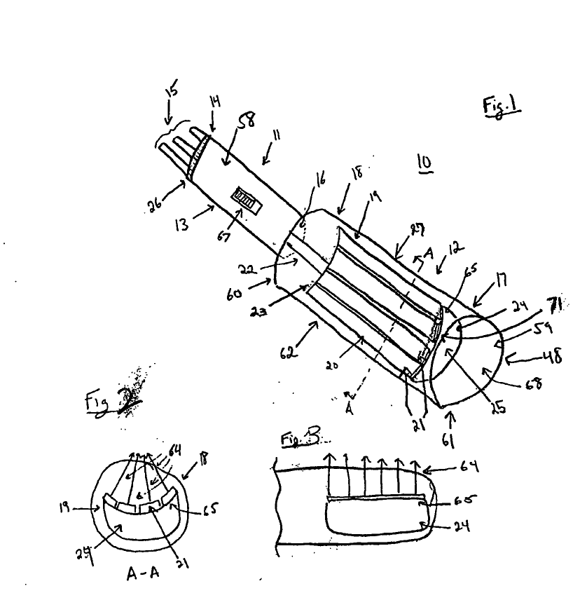

The apparatus of the present invention is shown in FIG. 1 and seen generally at 10. In one embodiment, the apparatus 10 may comprise a handle 11 which can be manipulated by a user. and a probe 12. The handle 11 may have a control element 67 thereon, or the control element 67 may be located on a control device located near an operating or examining area. The control element 67 may be a switch, button, dial, foot pedal or any other desired mechanism that will allow the user to activate the apparatus 10. The size, shape and orientation of the handle 13 may be varied to achieve a desired feel or balance, but is preferably substantially tubular or ergonomically shaped for gripping by a user's hand. Any suitable method of manufacturing, such as injection molding, machining, etc., may be used to construct the handle 13, from any suitable material (e.g. plastic, metal or combination thereof). The probe 12 is preferably manufactured from low-cost materials so that it may be employed as, for example, a single-use, disposable item. As would be understood by those skilled in the art, the size and shape of the probe 12 will be generally dictated by the anatomy with which it is to be used. For example, if the probe 12 is designed for use intra-vaginally, the probe 12 will preferably be no more than 6 to 7 cm long with a diameter of 1 to 4 cm.

The handle 13 may include a handle lumen 58 allowing power and feedback cables 15 and any other elements (e.g., fluid lumens) to pass through the handle lumen 58 from a proximal end 14 of the handle 13 to the second section 12. The elements passing through the handle 13 may include, for example, a power supply and other electric cords to and from the ultrasound device, drive shafts and other members for rotating the second section 12 relative to the handle 11, fluid lumens, and/or any other elements contained therein. A distal end 16 of the handle 13 is connected to and open into the second section 12. The diameter or cross-section of the handle 11 is preferably less than that of the second section 12 with the relative dimensions of the first and second sections 11, 12 depending on the application, user-defined preferences and the anatomy of the organs into which the device is to be introduced.

The second section 12 includes an operative probe 17 for applying energy to selected portions of tissue. The probe 17 extends from a proximal end 60 to a distal end 61, with a probe cavity 59 formed therein. The probe cavity 59 may be formed in any size and/or shape compatible with the anatomical structures through which the second section 12 will be inserted. The probe 17 preferably comprises a casing 18, an ultrasound element 19 and a coupling fluid component 48. The casing 18 may have any desired shape compatible with the anatomy with which it is to be employed. However, the shape of the casing 18 will preferably be formed so that a shape of a portion of the outer surface of the casing 18 through which energy will pass from the ultrasound element 19 to the target tissue couples to the tissue surface which it will be contacting (e.g., as a shape of the casing conforms to that of the tissue or vice versa). That is, as ultrasound energy will pass efficiently only when there are no air gaps between the ultrasound element 19 and the target tissue, it is important that the casing be shaped to ensure that direct contact with the intervening tissue surface may be easily maintained. For example, the casing 18 may be substantially cylindrical or may include a substantially planar face or faces. The casing 18 is more preferably a sonolucent dome or membrane with a coupling medium 68 filling the casing 18 to transmit the ultrasound waves from the ultrasound element 19 to the casing 18 and therethrough to the tissue. As would be understood by those skilled in the art, the coupling medium 68 may be a liquid (e.g., water, degassed water, etc.), a gel, or any other desired medium, preferably with an acoustic impedance similar to that of water. Furthermore, if this medium 68 is circulated, it will also assist in removing heat from the tissue in immediate contact with the casing 18 and this medium 68 or any other material suitable for use as the coupling medium 68 may also be applied to an outer surface of the casing 18 to reduce the chances of infection.

The handle 11 and the second section 12 of the apparatus 10 may be movably or immovably mounted to one another. In the embodiment shown in FIG. 1, the handle 11 and the second section 12 are fixedly coupled to one another in an axial alignment to reduce the arbitrariness of the waving of the apparatus 10 by a user. In a separate embodiment (not shown) the handle 11 and the second section 12 may be rotatably coupled to one another by a hinge as would be understood by those of skill in the art so that an angle of the second section 12 relative to the handle 11 may be dynamically or incrementally varied to aid in properly positioning the second section 12 relative to the target tissue. That is, the angle may be varied to facilitate placement of the second section 12 flush against the desired tissue surface adjacent to the target tissue to maximize energy delivery to the target tissue. As would be understood by those skilled in the art, the joint may be a locking hinge or any other coupling means which allows for dynamic and/or incremental movement of the second section 12 relative to the handle 11. Use of such a joint contemplates movement of the second section 12 in any or all directions (i.e. laterally, vertically, axially and angularly) relative to the handle 11.

As would be understood by those skilled in the art, any or all of the handle 11, the casing 18 and the balloon 28 may be manufactured from any biocompatible material (e.g., polyethylene, polypropylene, ethylene vinyl acetate (EVA), etc.) showing the desired mechanical properties. Hence, these portions of or the entire apparatus 10 may be employed as a single-use item and disposed of after use. Alternatively, the user may dispose of the casing 18 and/or the balloon 28 after each use while the remaining components of the apparatus 10 are conditioned and fitted with a new casing 18 and/or balloon 28 for subsequent use.

As shown in FIG. 1, an armature 22 extends through the handle 11 to the second section 12 where it is attached to a substrate 24 of the ultrasound element 19 residing within the casing 18. A proximal end of the armature 22 is coupled to a displacement actuator 26 so that, movement and/or rotation of the displacement actuator 26 relative to the handle 13 causes a corresponding movement of the armature 22 and, consequently, of the ultrasound element 19 relative to the casing 18. As would be understood by those skilled in the art, the displacement actuator 26 may include one or more of a disc, gear, lever, or other element which allows the user to rotate the armature 22 relative to the handle 13 and/or to move the armature 22 axially relative to the handle 13 to alter a direction of transmission of the ultrasound energy from the ultrasound element 19. Alternatively, the armature 22 may be adapted to rotate and/or move axially electronically, for example, through a combination of control logic circuits and servo motors. As would be understood by those skilled in the art, mechanical and/or electronic control of the axial movement and rotation of the ultrasound element 19 minimizes operator variability associated with devices requiring arbitrary waving of an RF applicator over target tissue.

FIG. 1 also shows one embodiment of the ultrasound element 19 according to the invention. In this embodiment, the ultrasound element 19 includes an array of ultrasound crystals 21 disposed on a concave surface 65 of the substrate 24. The ultrasound crystals 21, which may include, for example, be PZT (Lead Zirconate Titanate) or any other piezoelectric material. The ultrasound crystals are bonded to a substantially rigid intermediate plate 71 which is preferably formed of a material such as copper which may be strongly bonded to a the substrate 24 to prevent the ultrasound crystal 19 from shaking loose from the substrate 24 as it vibrates to generate the ultrasound energy. The intermediate plate 71 may be utilized for any shape, size and configuration of the ultrasound crystals 19. Preferably, a thin layer of epoxy will be used to bond the ultrasound crystal 19 to the intermediate plate 71 with an additional coat of epoxy applied to the intermediate plate 71 to bond it to the substrate 24. As would be understood by those skilled in the art, the epoxy may be replaced by another suitable adhesive compound or method, but preferably any compound used has an acoustic impedance similar to that of water. As would be understood by those skilled in the art, the number, size, shape and orientation of the ultrasound crystals 21 in any of the described embodiments may be varied to deliver the desired energy to the target tissue in the most efficient manner. For example, the crystals 21 may be concave, substantially planar, convex, etc. In addition, those skilled in the art will understand that the array of crystals 21 may be replaced by a single concave crystal having a shape similar to that of the array 21 so that a similar focus area for the generated energy is achieved.

For example, the apparatus 10 may be used to treat target tissues at depths between 0.5 and 3 cm below the surface with which the casing 18 is in contact. In the case of the EPF, the target tissue will generally be between 1 and 3 cm below the vaginal wall. For example, if crystals 21 are circular with a diameter D of approximately 1 cm, vibrating the crystals 21 at a frequency F of 2.5 MHz produces a beam of energy which remains focused for approximately a length L of 4 cm before diverging. As the velocity of sound is approximately 1,500m/sec, the wavelength λ is equal to 1,500m/sec*1/F and the distance is calculated as: L=D²/4λ. Thus, for a circular crystal 21 of 0.01 m diameter, L equals approximately 4 cm. This is the maximum focusing distance for an ultrasound element 19 including crystals 21 of these diameters at F=2.5 MHz. If the beam travels the entire distance through tissue, the maximum attenuation of the energy is 1 dB/MHz/cm*2.5 MHz*4 cm=10 dB. Thus, approximately one tenth of the original transducer power would remain at a focusing point at the distance L. Thus, to achieve a greater power at the focusing point than is generated by any individual crystal 21 at its surface, beams from more than 10 crystals would need to be focused on the focusing spot.

As would be understood by those skilled in the art, the ultrasound element 19 may either be fully enclosed in the casing 18 or may be exposed and in substantially the same plane as a surface 27 of the casing. If the ultrasound crystals 21 are in the same plane as the casing surface 27, rotation of the armature 22 will rotate the entire second section 12 of the apparatus.

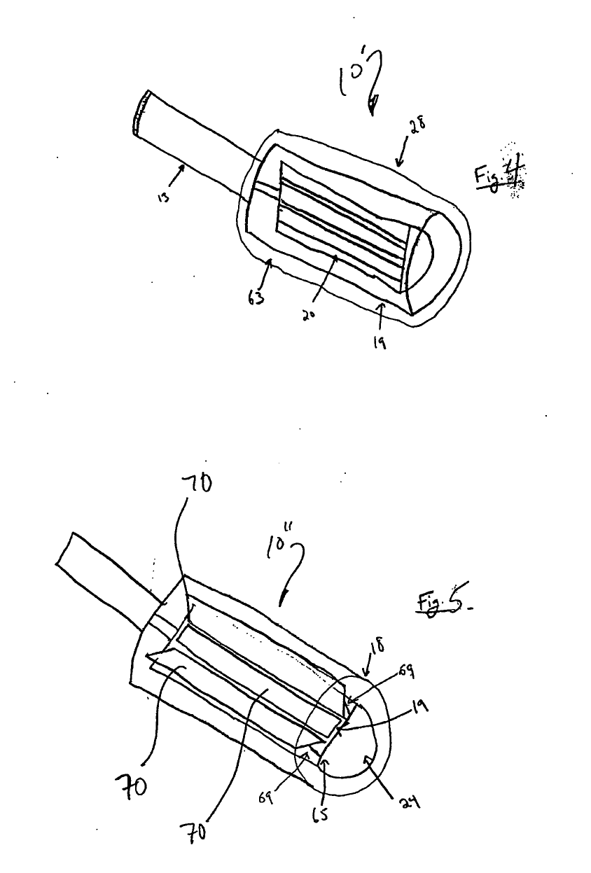

The ultrasound element 19 includes an array 20 of ultrasound crystals 21 positioned on a substrate 25. According to this embodiment, the surface 65 of the substrate 24 is concave and, therefore, the crystals 21 form a substantially cylindrical surface. As seen more clearly in FIG. 2, the surface 65 forms a shape with a focus along a line substantially parallel to a longitudinal axis of the ultrasound element 19 and separated therefrom by a preselected distance. More specifically, the surface 65 is shaped so that, when the intermediate plates 68 are bonded thereto with the crystals 21 bonded to the intermediate plates 68, the crystals 21 are arranged along a surface with a focus along a line substantially parallel to the longitudinal axis of the ultrasound element 19. Ultrasound energy from the crystals 21 will converge along this focus line substantially increasing the intensity of energy delivered along this line as compared to the energy delivered to other locations. As shown in FIG. 2, if four ultrasound crystals 21 are positioned on the surface 65 to form the ultrasound element 19, the energy from these four crystals 21 will come together at the focus line along the length of the element 19. Thus, the shape of the surface 65 dictates a distance to the line of focus and, consequently, determines the depth at which sufficient energy will be applied to tissue to denature the collagen and stiffen the tissue. That is, when the casing 18 is pressed against tissue, the focus line will be located at a predetermined depth within the tissue. Those skilled in the art will understand that the shape of the surface 65 may be altered in accord with the basic rules of geometry to achieve any other desired depths and/or curves along which the ultrasound energy is to be focused. For example, the shape of the surface 54 may be selected so that the focus distance varies along the longitudinal axis or so that the ultrasound crystals 21 focus on a single spot. A side profile of the ultrasound beam 64 emitted from the embodiment of FIG. 1 is seen in FIG. 3. For line focus applications, it may be necessary to select focusing distances that are considerably less than L as the number of crystals 21 which may be focused on each point of the line is less than may be required to compensate for the attenuation associated with greater depths.

As shown in FIG. 4, a apparatus 10′ according to a second embodiment includes a liquid filled balloon 28 surrounding the casing 18. As would be understood by those skilled in the art, the balloon 28 may be replaced by a sonolucent dome, membrane or any other suitable structure. Upon activation or initialization of the apparatus 10 or upon recognition of certain predetermined conditions, e.g. when a temperature of the ultrasound element 19 reaches a threshold level, an inflation lumen 63 of the balloon 28 supplies liquid to the balloon 28 with the liquid exiting the balloon 28 via a fluid return lumen. Alternatively, liquid may be constantly or regularly supplied to the balloon 28 to flow circumferentially therearound. Furthermore, as would be understood by those skilled in the art, where the casing 18 and/or the balloon 28 are compliant, the user may alter the focal distance of the ultrasound crystals 21 by increasing/decreasing the pressure of the fluid 68. This pressure or volume of the fluid 68 may be monitored with feedback provided to the user to achieve desired focal depths.

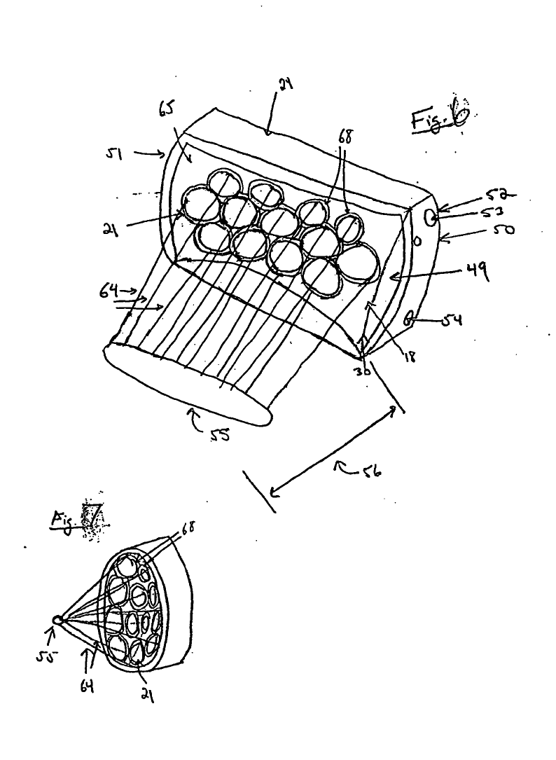

As shown in FIG. 5, the ultrasound element 19 of an apparatus 10″ according to a third embodiment of the invention includes crystals 21 mounted on a plurality of panels 70 which are moveable relative to one another. This allows the surface 65 to be dynamically shaped by mechanical or electromechanical means 69 (e.g, vertically moving actuators) to vary the depth and or shape of the area of focus approximating the cylindrical arrangement of the crystals 21 of the embodiment of FIG. 1 with different radii and, consequently, different focus depths. For example, a wider field may be narrowed and/or a depth of focus may be changed by increasing the angles between the outer panels 70 and the center panel 70, as shown in FIG. 5. Alternatively, the dynamic shaping of the ultrasound element 19 may be accomplished by incorporating shape memory materials (e.g, Ti—Ni alloys, Cu-based alloys, ferrous alloys, certain ceramics and polymers, smart materials, etc.) into the substrate 24 so that controlling a temperature of these materials (e.g., by applying electric current thereto) causes a corresponding change in the shape of the substrate 24 to achieve a desired energy focus.

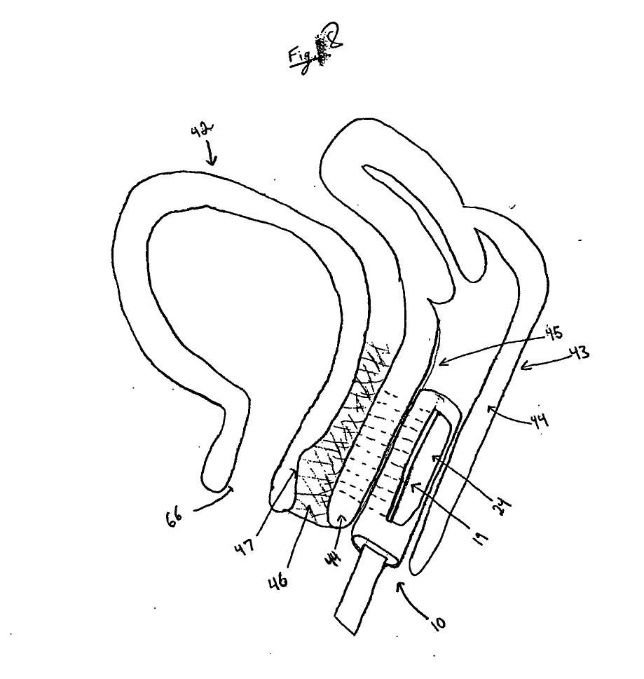

A further exemplary embodiment of an ultrasound element 19 is depicted in FIG. 6. In this embodiment, the substrate 24 includes an array of ultrasound crystals 21 disposed on a surface 65 that is substantially ellipsoidal. As would be understood by those skilled in the art, the ultrasound crystals 21 may be arranged in a single or multiple lines in either a longitudinal or a transverse orientation, or in any other orientation or grouping as desired. The ultrasound element 19 of this embodiment is concave in the form of a partially ellipsoidal bowl creating a substantially elliptical spot focus area 55 at a selected distance 56 from the element 19. Alternatively, as shown in FIG. 7, the surface 65 may be formed as a partially spherical bowl. The positioning of the ultrasound crystals 21 according to these embodiments creates a substantially circular spot field 55 in which the ultrasound beams 64 converge at a specific distance 56 from the substrate 24. As would be understood by those skilled in the art, any of the various ultrasound elements 19 may be employed with any of the various casings 18 and coverings described herein. As described above, when target tissue is at a depth which approaches a maximum depth of energy penetration (based on the crystal dimensions and frequency) before the energy dissipates, it is necessary to focus more crystals on a spot to account for attenuation of the energy. Specifically, in the example given above, for a target depth of 4 cm with crystals 21 of D=1 cm and F=2.5 MHz, it is necessary to focus more than 10 crystals 21 on the focusing spot to achieve greater power delivery at the focusing spot than is generated by each crystal. In each of FIGS. 6 and 7, 13 crystals are focused on the spot 55 bringing approximately 1.3 times the energy to this spot as is generated by any one crystal. Those skilled in the art will understand that the surface 65 in the example of FIG. 7 will be a sphere of approximately 4 cm diameter to achieve this depth of focus and that the surface 65 of the apparatus of FIG. 6 will be an ellipsoid with a focus approximately 4 cm from the end thereof.

Seen more clearly in FIG. 6, the substrate 24 has a substantially rectangular shape with a distal rounded edge 50 and a proximal rounded edge 51. As would be understood by those skilled in the art, the shape of the substrate 24 may be varied depending on application (e.g., a rounded distal edge 50 may ease insertion into a naturally occurring bodily orifice). As would be further understood by those skilled in the art, the depth of the target tissue, size of the target tissue, and other factors may influence determinations concerning the type, size and orientation of the crystals 21 and their number in the array of the element 19. The component 48 according to this embodiment includes a channel 52 extending through the substrate 24 from an inlet 53 to an outlet 54 so that the medium 68 may be circulated therethrough. The channel 52 may extend into the casing 18, longitudinally and/or radially winding around the ultrasound element 19 specifically within those parts of the casing 18 through which the ultrasound energy will pass toward the target tissue. Furthermore, in any of the described embodiments, a distance between an axial centerline, midpoint or face of the ultrasound element 19 and the outside of the casing 18 or cooling balloon 28 may be varied to change a depth of focus of the energy. Finally, a conduit 57 is provided for a wire to couple the ultrasound element 19 to a source of energy. Alternatively, the apparatus 10 may include wireless energy couplings.

FIG. 8 shows an apparatus 10 according to any of the previous embodiments in position within the vagina 43 in contact with the vaginal wall 44 and the vaginal muscosa 45. In this position, the apparatus 10 is positioned to transmit energy to the endopelvic fascia (EPF) 46 and/or the bladder neck tissues 47 which support the bladder 42 which, in large part, define the pelvic floor. As described above, urinary incontinence may develop when the bladder neck 47 shifts due to abdominal stress from obesity, pregnancy or other conditions. Pressure pulses to the abdomen caused by activities such as laughing, coughing, sneezing or exercising may then cause the bladder to shift vertically or laterally, decreasing the length of the urethra 66 and simultaneously opening the urinary sphincter, expelling urine. Displacement of the bladder 42 further stretches and deforms the EPF 46.

The method according to the present invention will be shown and described in conjunction with FIG. 7 as a treatment for urinary incontinence, though the method may be used for the treatment of other conditions where the reshaping and/or stiffening of tissue (e.g., collagenous tissue) may be therapeutic. The EPF 46 is stiffened non-invasively by inserting the apparatus 10 into a body lumen via a naturally occurring body orifice, such as, the vagina 43 until the second section 12 contacts the vaginal mucosa 45, because the cooling component 48 will protect the mucosa and vaginal wall 44 from any heating caused by inefficiencies of the ultrasound element 19.

The apparatus 10 may be inserted to any desired depth within the vagina 43, but the second section 12 is preferably introduced fully into the vagina 43 with the casing 18 in contact with the vaginal wall 44 and/or vaginal mucosa 45 to allow for efficient propagation ultrasound energy thereinto. After the apparatus 10 has been inserted into the vagina 43, the ultrasound element 19 may be statically placed in a medial or lateral position for the delivery of ultrasound energy to a target portion of collagenous tissue surrounding the vaginal wall 44, particularly the EPF. The ultrasound element 19 may then be rotated and/or translated axially, mechanically or electronically, to provide more thorough coverage of the target tissue, while avoiding damage to the surrounding tissue and structures. As discussed above, in some embodiments of the invention, tthe second section 12 may rotate relative to the handle 11. Additionally, positioning within the vagina 43 may be varied by manipulation of the handle 11 or through the use of a joint between the handle 11 and the probe 12 to change an angle therebetween. Hence, the ultrasound energy may be directed to the EPF near the bladder neck 47 and mid to proximal urethra 66 to treat stress incontinence.

The ultrasound element 19 delivers energy to the EPF 46 through the vaginal mucosa 45 and the vaginal wall 44. As described above, ultrasound energy denatures and reorients the collagenous fibers that compose the EPF, causing it to shrink and stiffen. Stiffening of the collagen pulls the bladder 42, bladder neck 47 and proximal urethra 66 toward their initial positions before the stress factor (i.e. obesity, pregnancy) caused their displacement so that abdominal stress during routine activities will no longer result in expulsion of urine from the urethra.

Those skilled in the art will understand that the crystals 21 of any of the above described ultrasound elements 19 may be operated as a phased array to adjust the depth, shape and/or size of the focus area of the ultrasound energy and that the frequency of the energy delivered by the ultrasound element 19 may be varied to depending on the depth of the target tissue to achieve a maximum energy delivery to this tissue while minimizing the impact of the energy on surrounding tissues.

The present invention has been described with reference to specific exemplary embodiments. Those skilled in the art will understand that changes may be made in details, particularly in matters of shape, size, material and arrangement of parts. Accordingly, various modifications and changes may be made to the embodiments. For example, the type of ultrasound array used may be varied, and the shape of the ultrasound crystals may be changed. Additional or fewer components may be used, depending on the condition that is being treated using the described tissue stiffening apparatus. The specifications and drawings are, therefore, to be regarded in an illustrative rather than a restrictive sense.

What is claimed is:

1. An apparatus for stiffening tissue comprising: an ultrasound element including an array of ultrasound crystals arranged on a surface, the surface shaped so that energy generated by the crystals converges on a predetermined focusing area.

2. An apparatus according to claim 1, further comprising a mechanism for moving at least a part of the surface to vary a shape of the surface so that at least one of a location, a size and a shape of the focusing area is adjusted.

3. An apparatus according to claim 2, wherein the mechanism for moving includes a shape memory component formed of a shape memory material and a heating mechanism for heating the shape memory component above a critical temperature of the shape memory material so that the shape memory component assumes a predetermined shape.

4. An apparatus according to claim 1, further comprising a casing surrounding the ultrasound element, the casing including a coupling medium therein for propagating sound waves from the crystals therethrough to tissue with which the casing is in contact.

5. An apparatus according claim 4, further comprising a circulation system for circulating the coupling medium through the casing to dissipate heat generated adjacent to the casing

6. An apparatus according to claim 4, wherein the casing includes a balloon which, when placed in contact with tissue, conforms to a shape thereof.

7. An apparatus according to claim 1, further comprising a handle which, when the device is in an operative position, remains outside the body, and a probe including the ultrasound element, the probe being coupled to the handle so that, when the device is in the operative position, the probe is located within the body with the ultrasound element located in proximity to a target portion of tissue.

8. An apparatus according to claim 7, wherein the handle is coupled to the probe via a joint allowing angular movement of the probe relative to the handle.

9. An apparatus according to claim 8, wherein the joint further allows for rotation of the probe relative to the handle about an axis of the probe.

10. An apparatus according to claim 1, wherein the surface is shaped as a portion of a sphere.

11. An apparatus according to claim 1, wherein the surface is shaped as a portion of an ellipsoid.

12. An apparatus according to claim 1, wherein the surface includes a plurality of panels movably connected to one another so that a shape of the surface may be varied.

13. An apparatus according to claim 7, further comprising a displacement member coupled to the ultrasound element, the displacement member extending to the handle so that, movement of the displacement member moves the ultrasound element relative to the probe.

14. An apparatus according to claim 13, wherein rotation of the displacement rotates the ultrasound element relative to the handle.

15. An apparatus according to claim 14, wherein the probe includes a casing surrounding the ultrasound element and wherein movement of the displacement member relative to handle moves the ultrasound element relative to the casing.

16. An apparatus according to claim 1, wherein the ultrasound crystals include at least one of planar crystals, circular crystals and concave crystals.

17. An apparatus according to claim 1, wherein the array is a phased array.

19. An apparatus according to claim 17, wherein the phased array controls a depth of focus and a depth of penetration of the ultrasound energy.

20. An apparatus according to claim 4, wherein the casing is one of a sonolucent dome and a sonolucent membrane.

21. An apparatus according to claim 1, wherein each of the ultrasound crystals is bonded to an intermediate member which is bonded to the surface.

22. An apparatus according to claim 21,wherein the intermediate members include copper.

23. An apparatus according to claim 22, wherein the substrate is formed of a plastic and wherein the intermediate member is bonded thereto by epoxy.

24. An apparatus for treating tissue comprising a probe which, when in an operative position, is located adjacent to a portion of tissue to be treated, the probe including an ultrasound element, the ultrasound element focusing ultrasound energy on a predetermined focus area determined by the geometry of the ultrasound element.

25. An apparatus according to claim 24, wherein the ultrasound element includes a plurality of ultrasound crystals arranged on a substrate, the substrate being shaped so that energy from the crystals converges on the predetermined focus area.

26. A method of treating tissue comprising:
positioning adjacent a target portion of tissue to be treated a probe including an ultrasound element, a geometry of the ultrasound element focusing ultrasound energy generated thereby on a predetermined focus area;
adjusting the position of the probe so that the predetermined focus area is located at the target portion of tissue; and
energizing the ultrasound element to treat the target portion of tissue.

27. A method according to claim 26, wherein the ultrasound element includes an array of ultrasound crystals arranged in a shape focused on the predetermined focus area.

28. A method according to claim 26, further comprising moving the ultrasound element to apply energy to additional portions of tissue.

29. A method according to claim 28, wherein the ultrasound element is moved relative to a casing of the probe.

30. A method according to claim 28, wherein the ultrasound element is moved by moving the probe.
